(19) United States
(12) Patent Application Publication
(10) Pub. No.: US 2026/0246984 A1
(43) Pub. Date: Aug. 20, 2026

(54) VIDEO RECOMMENDATION METHOD, APPARATUS, ELECTRONIC DEVICE, STORAGE MEDIUM, AND PROGRAM PRODUCT

(71) Applicant: Beijing Youzhuju Network Technology Co., Ltd., Beijing (CN)

(72) Inventors: Wei ZHOU, Beijing (CN); Zesheng WANG, Beijing (CN); Buyu LONG, Beijing (CN); Dan YE, Beijing (CN); Xiaodan HANG, Beijing (CN); Wei WU, Beijing (CN); Pu WANG, Beijing (CN); Haiwen WU, Beijing (CN); Kangyu TU, Beijing (CN); Jing LIANG, Beijing (CN)

(21) Appl. No.: 19/537,407

(22) Filed: Feb. 11, 2026

(30) Foreign Application Priority Data
Feb. 14, 2025 (CN) 202510169934.6

(51) Int. Cl. H04N 21/234

(52) U.S. Cl. CPC H04N 21/23424

(57) ABSTRACT

The present disclosure relates to the technical field of data processing, and discloses a video recommendation method and apparatus, an electronic device, a storage medium and a program product. The method includes: determining, in response to a first condition input on a first page, a historical live streaming video satisfying the first condition; displaying, in a display area of a second page, a display unit of at least one video segment in the historical live streaming video; displaying, in the display area of the first page, a first video segment in response to a selection instruction for the first video segment; and pushing the first video segment in response to an interaction operation on a push control in the first page.

### CROSS-REFERENCE TO RELATED APPLICATIONS

The present application is based on and claims the benefit of the priority to the Chinese application No. 202510169934.6 filed on February 14, 2025, the disclosure of which is incorporated herein in its entirety.

### TECHNICAL FIELD

The present disclosure relates to the field of data processing technologies and, in particular, to a video recommendation method, an apparatus, an electronic device, a storage medium and a program product.

### BACKGROUND

With the development of Internet technologies, live streaming has gradually become an important channel for many users to introduce products, display brands, and interact and communicate with each other, thanks to its characteristics such as real-time, interactivity and authenticity.

### SUMMARY

In view of this, the present disclosure provides a video recommendation method, an apparatus, an electronic device, a storage medium and a program product.

In a first aspect, the present disclosure provides a video recommendation method, including: determining, in response to a first condition input on a first page, a historical live streaming video satisfying the first condition;

displaying, in a display area of a second page, a display unit of at least one video segment in the historical live streaming video, where the display unit is configured to display the video segment and analysis data of the video segment, the video segment is used to display a product, and the video segment is determined based on effectiveness of live streaming of respective live streaming clips from the historical live streaming video; and

displaying, in a display area of the first page, a first video segment in response to a selection instruction for the first video segment in the at least one video segment, where the first video segment is a video segment for recommendation.

In a second aspect, the present disclosure provides a video recommendation apparatus, including:

a first processing module, configured to determine, in response to a first condition input on a first page, a historical live streaming video satisfying the first condition;

a first display module, configured to display, in a display area of a second page, a display unit of at least one video segment in the historical live streaming video, where the display unit is configured to display the video segment and analysis data of the video segment, the video segment is used to display a product, and the video segment is determined based on effectiveness of live streaming of respective live streaming clips from the historical live streaming video; and

a second display module, configured to display, in a display area of the first page, a first video segment in response to a selection instruction for the first video segment in the at least one video segment, where the first video segment is a video segment for recommendation.

In a third aspect, the present disclosure provides an electronic device, including: a memory and a processor, where the memory and the processor are communicatively connected to each other, the memory stores computer instructions, and the processor executes the computer instructions to implement the video recommendation method according to the above first aspect or any implementation corresponding thereto.

In a fourth aspect, the present disclosure provides a computer-readable storage medium storing computer instructions, where the computer instructions are used to cause a computer to perform the video recommendation method according to the above first aspect or any implementation corresponding thereto.

In a fifth aspect, the present disclosure provides a computer program product including computer instructions, where the computer instructions are used to cause a computer to perform the video recommendation method according to the above first aspect or any implementation corresponding thereto.

### BRIEF DESCRIPTION OF THE DRAWINGS

In order to more clearly illustrate the technical solutions in the specific embodiments of the present disclosure or in the prior art, the following will briefly introduce the drawings that need to be used in the description of the specific embodiments or the prior art. Obviously, the drawings in the following description are some embodiments of the present disclosure. For those of ordinary skill in the art, other drawings may also be obtained based on these drawings without creative efforts.

FIG. 1 is a schematic flowchart of a video recommendation method according to an embodiment of the present disclosure;

FIG. 2 is a schematic diagram of a second page according to an embodiment of the present disclosure;

FIG. 3 is a schematic flowchart of another video recommendation method according to an embodiment of the present disclosure;

FIG. 4 is a schematic diagram of a first page according to an embodiment of the present disclosure;

FIG. 5 is a schematic interaction diagram of a product information filtering control according to an embodiment of the present disclosure;

FIG. 6 is a schematic diagram of a third page according to an embodiment of the present disclosure;

FIG. 7 is a schematic diagram of a first video segment displayed by a receiver according to an embodiment of the present disclosure;

FIG. 8 is a structural block diagram of a video recommendation apparatus according to an embodiment of the present disclosure; and

FIG. 9 is a structural block diagram of an electronic device according to an embodiment of the present disclosure.

### DETAILED DESCRIPTION

In order to make the purpose, technical solutions and advantages of the embodiments of the present disclosure clearer, the technical solutions in the embodiments of the present disclosure will be described clearly and completely below in combination with the drawings in the embodiments of the present disclosure. Obviously, the described embodiments are part of the embodiments of the present disclosure, not all of them. Based on the embodiments in the present disclosure, all other embodiments obtained by those skilled in the art without creative efforts belong to the protection scope of the present disclosure.

It may be understood that before using the technical solutions disclosed in the embodiments of the present disclosure, users should be informed of the type, range of use, use scenarios, etc. of personal information involved in the present disclosure and obtain the authorization of users in an appropriate manner in accordance with relevant laws and regulations.

For example, in response to receiving an active request from a user, prompt information is sent to the user to clearly prompt the user that the requested operation will require access to and use of the user's personal information. As such, the user may independently choose whether to provide personal information to software or hardware, such as an electronic device, an application, a server or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also include a filtering control for the user to choose whether to "agree" or "disagree" to provide the personal information to the electronic device.

It may be understood that the above process of notifying and obtaining user authorization is only illustrative, and does not constitute a limitation on the implementations of the present disclosure. Other manners that satisfy relevant laws and regulations may also be applied in the implementations of the present disclosure.

It may be understood that the data involved in the technical solution (including but not limited to the data itself, acquisition or use of the data) should comply with requirements of corresponding laws, regulations and related provisions.

With the development of Internet technologies, live streaming has gradually become an important channel for many users to introduce products, display brands, and interact and communicate with each other, thanks to its characteristics such as real-time, interactivity and authenticity. However, in practical applications, the effectiveness of live streaming is poor due to insufficient exposure of some live streaming videos.

Based on this, it is proposed in the related art to set up a black box switch for enabling a video segment of a live streaming video. After the black box switch is enabled, a historical live streaming video of a configured live streaming object is automatically clipped based on preset plan details to form a video segment, which is then pushed as a creative material. In addition, information about each pushed video segment, a segment title of the video segment, a plan to which the video segment belongs, and the like are separately summarized into a card for display. However, in order to push different types of video segments, this solution needs to configure different plan details, which leads to high maintenance costs and low utilization.

In other related technologies, a historical live streaming video is determined by selecting a live streaming source, and a video segment of the historical live streaming video is presented on a page for selection. However, when optional video segments are presented, the similarity between the video segments is high, and it is difficult for users to decide which video segment to push. Therefore, the utilization is low.

In view of this, according to an embodiment of the present disclosure, an embodiment of a video recommendation method is provided. It should be noted that the steps shown in the flowcharts of the drawings may be executed in a computer system such as a set of computer executable instructions, and although a logical order is shown in the flowcharts, in some cases, the steps shown or described may be executed in an order different from that here.

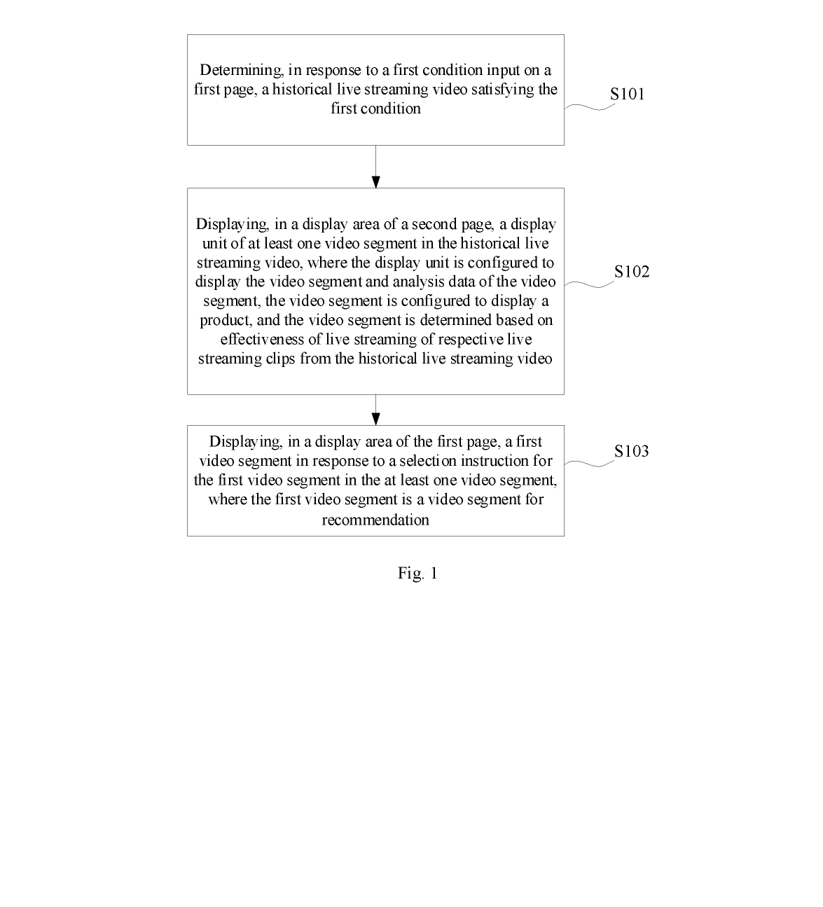

In this embodiment, a video recommendation method is provided, which may be used for a media service platform. FIG. 1 is a schematic flowchart of a video recommendation method according to an embodiment of the present disclosure. As shown in FIG. 1, the process includes the following steps:

Step S101: determining, in response to a first condition input on a first page, a historical live streaming video satisfying the first condition.

Optionally, the first condition includes an identification of a live streaming object, such as a live streaming account. The historical live streaming video includes a video during a historical live streaming process of the live streaming object and a video that has been streamed during a current live streaming process.

Optionally, an input control is displayed in a condition area of the first page, and the first condition is input through the input control.

In practical applications, in order to avoid an excessive data volume of historical live streaming videos, a time range of historical live streaming videos may be preset, for example, historical live streaming videos launched within the last 90 days.

Step S102: displaying, in a display area of a second page, a display unit of at least one video segment in the historical live streaming video, where the display unit is configured to display the video segment and analysis data of the video segment, the video segment is used to display a product, and the video segment is determined based on effectiveness of live streaming of respective live streaming clips from the historical live streaming video.

The live streaming clip is obtained by segmenting the historical live streaming video according to a time period, a theme or a displayed product.

Optionally, the display unit of the video segment is displayed in a form of a card. Specifically, the display unit of the video segment is displayed in a form of left and right card arrangement to display more video segments and analysis data thereof.

Optionally, the video segment is used to display one or more products. In practical applications, the video segment may be determined based on an analysis result of an analysis indicator of each live streaming clip from the historical live streaming video. The analysis indicator is used to characterize the effectiveness of live streaming of the corresponding live streaming clip, and includes at least one of a click-through rate of a live streaming room and a click-through rate of a product control, where the product control is used to display product information of a product. In addition, the analysis indicator may also adopt other indicators related to the effectiveness of live streaming of the historical live streaming video, which is not limited here.

Specifically, the click-through rate of the live streaming room is a ratio of a number of objects entering the live streaming room corresponding to the live streaming clip to watch within a time range of the live streaming clip to a number of objects presented with the live streaming room. That is, click-through rate of the live streaming room = number of objects entering the live streaming room to watch / number of objects presented with the live streaming room * 100%.

Specifically, the click-through rate of the product control is a ratio of a number of objects clicking on the product control to a number of objects presented with the product control within the time range of the live streaming clip. That is, click-through rate of the product control = number of objects clicking on the product control / number of objects presented with the product control * 100%.

Exemplarily, taking the analysis indicator being the click-through rate of the live streaming room as an example, the video segment may be determined based on the click-through rate of the live streaming room. For example, if the click-through rate of the live streaming room of any live streaming clip from the historical live streaming video is greater than a preset click-through rate threshold, the live streaming clip is determined as a video segment.

In addition, in practical applications, a pre-trained target model may also be used to analyze the effectiveness of live streaming of each live streaming clip from the historical live streaming video to determine the video segment. The target model is obtained by training based on a live streaming video sample, a live streaming information sample of the live streaming video sample and a segment label, where the segment label represents a recommendable segment in the live streaming video sample. Input data of the target model includes the historical live streaming video and live streaming information of the historical live streaming video.

It should be noted that in practical applications, there may be no video segment due to poor effectiveness of live streaming of some historical live streaming videos.

In practical applications, a determination time of the video segment may be preset, for example, pulling a live streaming video that was closed before 24:00 of a previous day after 10:00 every day to determine a video segment of the closed live streaming video. The closed live streaming video here includes the above historical live streaming video.

Step S103: displaying, in a display area of the first page, a first video segment in response to a selection instruction for the first video segment in the at least one video segment, where the first video segment is a video segment for recommendation.

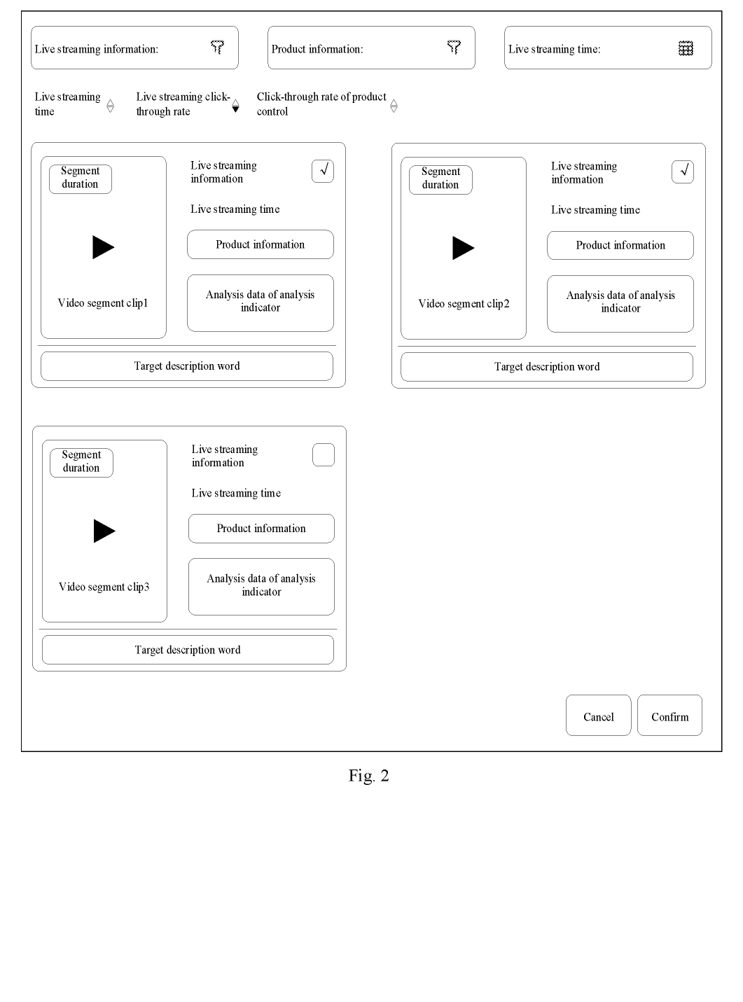

Specifically, in the second page, a filtering control is displayed in the display unit of the video segment, and the video segment is selected through an interaction operation with the filtering control to obtain the selected first video segment. Exemplarily, as shown in FIG. 2, taking the video segments clip1, clip2 and clip3 as an example, a filtering control is provided in the upper right corner of the display unit, and the first video segment to be pushed may be selected through the filtering control. For example, the video segments clip1 and clip2 are selected as the first video segment.

Meanwhile, a first confirmation control is also displayed in the second page, and after the first video segment is selected, the first video segment is displayed in the display area of the first page through an interaction operation with the first confirmation control.

In practical applications, after the first video segment is selected, the selected first video segment may also be displayed in a target area of the second page.

In addition, a first cancel control is also displayed in the second page, and the selection operation for the video segment in the second page is cancelled through an interaction operation with the first cancel control.

Optionally, the second page may be displayed on one side of the first page in a form of a foldable panel.

Further, a push control is also displayed on the first page, and the push control is used to trigger pushing of the first video segment. After the first video segment is displayed in the display area of the first page, the video recommendation method of the present disclosure further includes: pushing the first video segment in response to an interaction operation on the push control in the first page, such that a receiver of the first video segment displays the first video segment and the first video segment is associated with a live streaming link, where the live streaming link is determined based on the first condition.

According to the video recommendation method provided in this embodiment, after a first condition is input on a first page, a historical live streaming video satisfying the first condition is determined. Then, a video segment in the historical live streaming video is displayed in a display area of a second page; where, the video segment is determined based on effectiveness of live streaming of respective live streaming clips from the historical live streaming video. Therefore, a first video segment with better effectiveness of live streaming may be selected therefrom for recommendation. Furthermore, the first video segment may be used for recommendation to increase the exposure of a live streaming video of a corresponding live streaming object, thereby improving the effectiveness of the live streaming video.

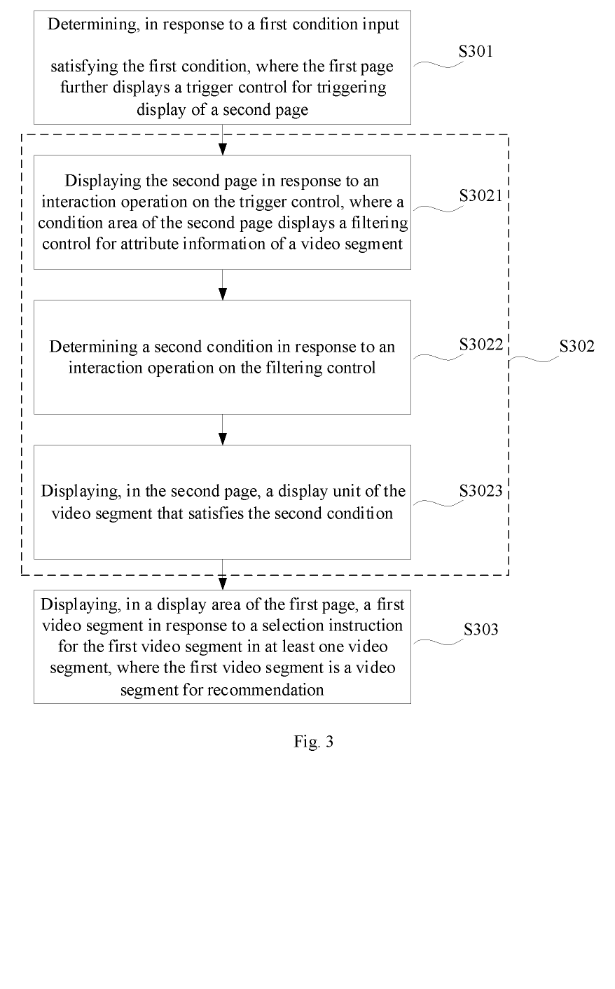

In this embodiment, another video recommendation method is provided, which may be used for a media service platform. FIG. 3 is a schematic flowchart of a video recommendation method according to an embodiment of the present disclosure. As shown in FIG. 3, the process includes the following steps:

Step S301: determining, in response to a first condition input on a first page, a historical live streaming video satisfying the first condition, where the first page further displays a trigger control for triggering display of a second page.

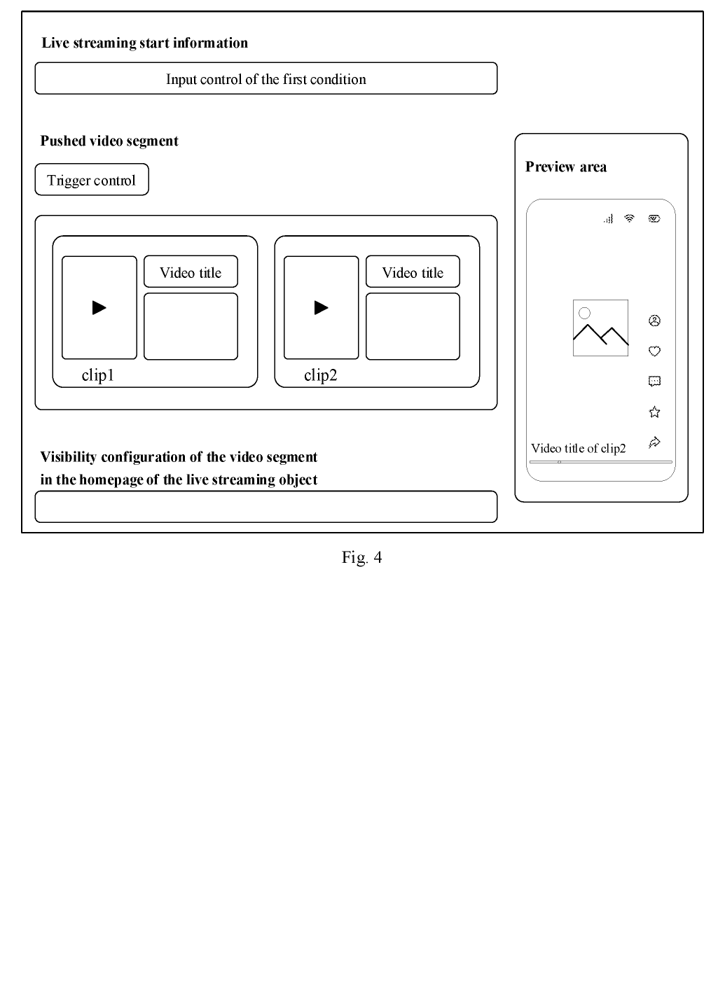

Exemplarily, referring to FIG. 4, after the first condition is input through the input control in the first page, the display of the second page may be triggered through an interaction operation of the trigger control in the first page.

Step S302: displaying, in a display area of the second page, a display unit of at least one video segment in the historical live streaming video, where the display unit is configured to display the video segment and analysis data of the video segment, the video segment is used to display a product, and the video segment is determined based on effectiveness of live streaming of respective live streaming clips from the historical live streaming video.

Specifically, the above step S302 includes:

S3021: displaying the second page in response to an interaction operation on the trigger control, where a condition area of the second page displays a filtering control for attribute information of the video segment.

Optionally, the attribute information of the video segment includes at least one of: live streaming information of the historical live streaming video to which the video segment belongs, displayed product information, and live streaming time. The live streaming information includes live streaming room information, such as a live streaming room name, and the product information includes a product name.

S3022: determining a second condition in response to an interaction operation on the filtering control.

Exemplarily, as shown in FIG. 2, the attribute information of the video segment may be determined through an interaction operation of the filtering control for the attribute information to obtain the second condition. For example, live streaming information is configured as a live streaming room room1 through a filtering control of the live streaming information, and the second condition includes the live streaming room room1. Product information is configured as a product A through a filtering control of the product information, and the second condition includes the product A. Live streaming time is configured as 2025-01-01 through a filtering control of the live streaming time, and the second condition includes 2025-01-01.

Specifically, in response to the interaction operation on the filtering control, at least one optional condition of corresponding attribute information is displayed. In response to a selection operation for the at least one optional condition, the second condition is determined. The optional condition is related to the attribute information of each video segment in the historical live streaming video.

Exemplarily, referring to FIG. 5, if a product A, a product B and a product C are displayed in the video segment of the historical live streaming video, through an interaction operation with the filtering control of the product information, the product A, the product B and the product C are displayed in a form of a menu list, and target product information is determined therefrom to obtain the second condition. For example, if the product A and the product B are selected as the target product information, a video segment for displaying the product A and the product B is displayed on the second page.

S3023: displaying, in the second page, the display unit of the video segment that satisfies the second condition.

Exemplarily, if the second condition includes the live streaming room room1 and the product A, a video segment that is streamed in the live streaming room room1 and used to display the product A, such as video segments clip1, clip2 and clip3, is filtered out from the video segment of the historical live streaming video, and display units of the video segments clip1, clip2 and clip3 are displayed on the second page.

Step S303: displaying, in a display area of the first page, a first video segment in response to a selection instruction for the first video segment in the at least one video segment, where the first video segment is a video segment for recommendation. Reference may be made to the above step S103, which will not be repeated in detail here.

According to the video recommendation method provided in this embodiment, the filtering control for the attribute information of the video segment is displayed in the condition area of the second page, so as to filter the video segment displayed in the second page through the interaction operation of the filtering control. Therefore, a required video segment may be quickly found.

In some optional implementations, the analysis data includes the attribute information of the video segment, and the attribute information includes at least one of: live streaming information of the historical live streaming video to which the video segment belongs, displayed product information, and live streaming time.

According to the video recommendation method provided in this embodiment, the attribute information such as the live streaming information of the historical live streaming video to which the video segment belongs, the displayed product information and the live streaming time is displayed in the display unit of the video segment, so that it is convenient to distinguish each video segment to assist in deciding the first video segment to be recommended.

In some optional implementations, the analysis data includes an analysis result of at least one analysis indicator, and the second page further displays a sorting control for the at least one analysis indicator, where the sorting control is used to sort and display the display units in the second page based on the analysis indicator.

Exemplarily, as shown in FIG. 2, a sorting control of a live streaming click-through rate and a sorting control of a click-through rate of a product control are also displayed on the second page, and the display units on the second page may be sorted and displayed based on the live streaming click-through rate through an interaction operation of the sorting control of the live streaming click-through rate. Alternatively, the display units on the second page are sorted and displayed based on the click-through rate of the product control through an interaction operation of the sorting control of the click-through rate of the product control.

According to the video recommendation method provided in this embodiment, the sorting control of each analysis indicator is configured on the second page, so as to sort and display the display units on the second page according to the analysis indicator. Therefore, a display sequence of the display units may be flexibly adjusted to preferentially display the display unit of the video segment with better effectiveness of live streaming.

In some optional implementations, the second page further displays a sorting control for the attribute information, and the sorting control is used to sort and display the display units in the second page based on the attribute information.

Exemplarily, as shown in FIG. 2, a sorting control of live streaming time is also displayed on the second page, and the display units on the second page may be sorted and displayed based on the live streaming time through an interaction operation of the sorting control.

In some optional implementations, the analysis data includes a target description word of voice-over script in the video segment.

Specifically, the target description word is determined based on interaction data corresponding to respective description words in the voice-over script. The interaction data includes video views, a click-through rate of a product control, and the like. Alternatively, target voice-over content is determined based on interaction data of respective voice-over content in the voice-over script, for example, voice-over content of which the interaction data satisfies a preset interaction condition is used as the target voice-over content. Then, the target description word is determined in the target voice-over content, where the target description word is a description word with a highest frequency of occurrence in the target voice-over content, or a description word used to characterize a theme of the target voice-over content.

According to the video recommendation method provided in this embodiment, the target description word of the voice-over script in the video segment is displayed in the display unit of the video segment, so that more decision-making information may be provided to facilitate selection of the first video segment to be recommended from multiple dimensions.

In some optional implementations, the video recommendation method of the present disclosure further includes: in response to an interaction operation on a second video segment in the at least one video segment, presenting, in a third page, the second video segment, a target description word of the second video segment, and voice-over information of the target description word in voice-over script.

Specifically, the third page is provided with a first area and a second area, the first area is used to display the second video segment, and the second area is used to display the target description word of the second video segment and the voice-over information of the target description word in the voice-over script.

The voice-over information includes at least one of: voice-over content corresponding to the target description word in the voice-over script and a time range of the voice-over content in the second video segment.

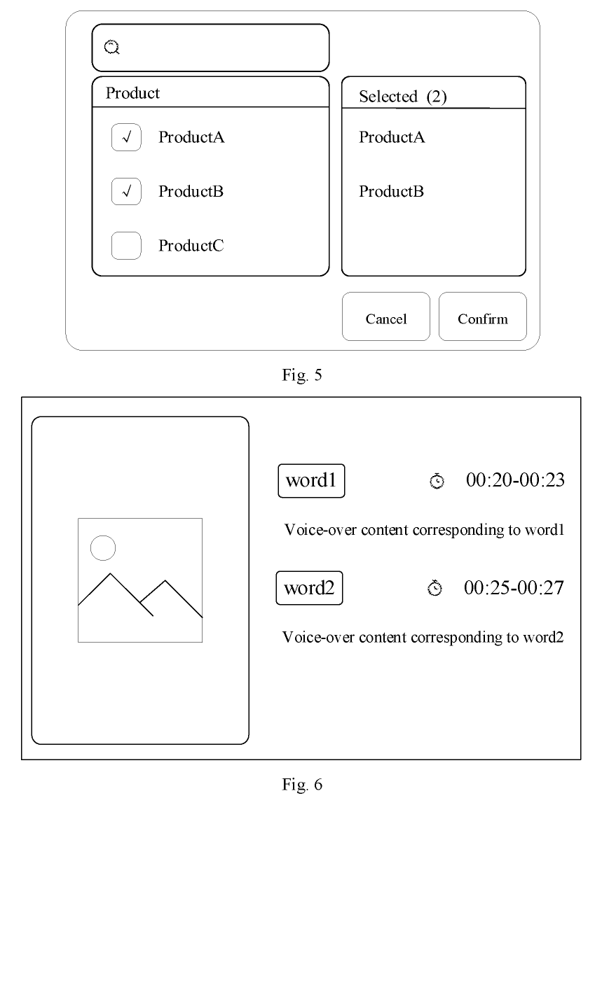

Exemplarily, referring to FIG. 6, taking the second video segment being the video segment clip2 as an example, the third page is displayed when interacting with the video segment clip2 on the second page. The video segment clip2 and the target description word of the video segment clip2, such as word1 and word2, are displayed on the third page. Meanwhile, the voice-over information of the target description word is displayed in a corresponding area of the target description word, such as voice-over content of word1, a time range of the voice-over content of word1 in the video segment clip2 (such as 00:20-00:23), voice-over content of word2, and a time range of the voice-over content of word2 in the video segment clip2 (such as 00:25-00:27).

According to the video recommendation method provided in this embodiment, the target description word of the second video segment and the voice-over information of the target description word in the voice-over script are presented on the third page, so that the main content in the second video segment may be quickly understood by using the target description word and the voice-over information.

In some optional implementations, the video recommendation method of the present disclosure further includes: determining, in response to an interaction operation on the target description word or the voice-over information, a target time point in the second video segment corresponding to the target description word or the voice-over information; and playing the second video segment from the target time point.

Exemplarily, as shown in FIG. 6, if the voice-over content corresponding to word1 is interacted with, a start time point of the voice-over content in the second video segment is used as the target time point. If the time range corresponding to word1 is interacted with, a start time point of the time range is used as the target time point.

According to the video recommendation method provided in this embodiment, the corresponding content of the second video segment is played by interacting with the target description word or the voice-over information, so that it is possible to support positioning to a specified position of the second video segment for viewing, thereby quickly positioning the content to be understood in the second video segment.

In some optional implementations, the first page further displays a preview area. The video recommendation method of the present disclosure further includes: displaying, in the preview area, preview content of a selected first video segment in response to a selection operation for the first video segment in the first page.

Exemplarily, referring to FIG. 4, if the video segment clip2 in the first page is selected, the preview content of the video segment clip2 is displayed in the preview area. If the recommendation information includes a video title, the preview content includes the video segment clip2 and the video title.

Specifically, the preview content includes display content of the first video segment on the receiver.

According to the video recommendation method provided in this embodiment, the preview content of the first video segment selected in the first page is displayed through the preview page, so that it is convenient to view the display effect of the pushed first video segment.

In some optional implementations, the first page further displays a push control and a recommendation configuration item for the first video segment. The video recommendation method of the present disclosure further includes:

Step a1: acquiring a live streaming link that satisfies the first condition.

Optionally, the live streaming link is a link to a current live streaming video of a live streaming object that satisfies the first condition, or the live streaming link is a link to a live streaming room that satisfies the first condition.

Step a2: determining, in response to a configuration operation for the recommendation configuration item, recommendation information of the first video segment.

The recommendation configuration item includes at least one of a first configuration item and a second configuration item, where the first configuration item is used to configure a video title of the first video segment, and the second configuration item is used to configure visibility of the first video segment in a homepage of the live streaming object.

Exemplarily, referring to FIG. 4, taking the first video segment being the video segments clip1 and clip2 as an example, in the display area of the first page, the first configuration item of the video title is displayed in an area corresponding to the video segments clip1 and clip2, and a video title of the video segment clip1 and a video title of the video segment clip2 may be configured through the first configuration item. Meanwhile, the second configuration item is also displayed on the first page, and the visibility of the video segments clip1 and clip2 in the homepage of the live streaming object may be configured through the second configuration item, for example, the video segments clip1 and clip2 are invisible and not displayed in the homepage of the live streaming object.

Step a3: pushing the first video segment, the recommendation information and the live streaming link in response to an interaction operation on the push control, where related display content of the first video segment is related to the recommendation information and the live streaming link.

The related display content of the first video segment includes content displayed in a corresponding display area when the first video segment is displayed on the receiver. For example, the video title of the first video segment and an object control of the live streaming object to which the first video segment belongs. The related display content of the first video segment further includes a display manner of the first video segment on the receiver, for example, whether the first video segment is displayed in the homepage of the live streaming object.

As an example, if the recommendation information includes the video title of the first video segment, when displaying the first video segment, the receiver displays the video title of the first video segment in the display area of the first video segment. If the recommendation information includes the visibility configuration of the first video segment in the homepage of the live streaming object, when displaying the homepage of the live streaming object, the receiver determines a display condition of the first video segment in the homepage of the live streaming object based on the visibility configuration.

Further, the above step a3 includes: in response to a video request initiated by the receiver, pushing the first video segment, the recommendation information and the live streaming link to the receiver. The receiver is used to display the first video segment, and an object control is displayed in a corresponding display area of the first video segment. The object control is used to represent the live streaming object corresponding to the first video segment, and the object control is associated with the live streaming link. The live streaming link is accessed by interacting with the object control to display the live streaming video of the live streaming object.

According to the video recommendation method provided in this embodiment, the recommendation configuration item for the first video segment is displayed on the first page to configure the recommendation information of the first video segment, so that a recommendation manner of the first video segment in the receiver may be flexibly adjusted. In addition, when the first video segment is pushed, the live streaming link that satisfies the first condition is pushed to increase live streaming exposure of the live streaming object of the first video segment.

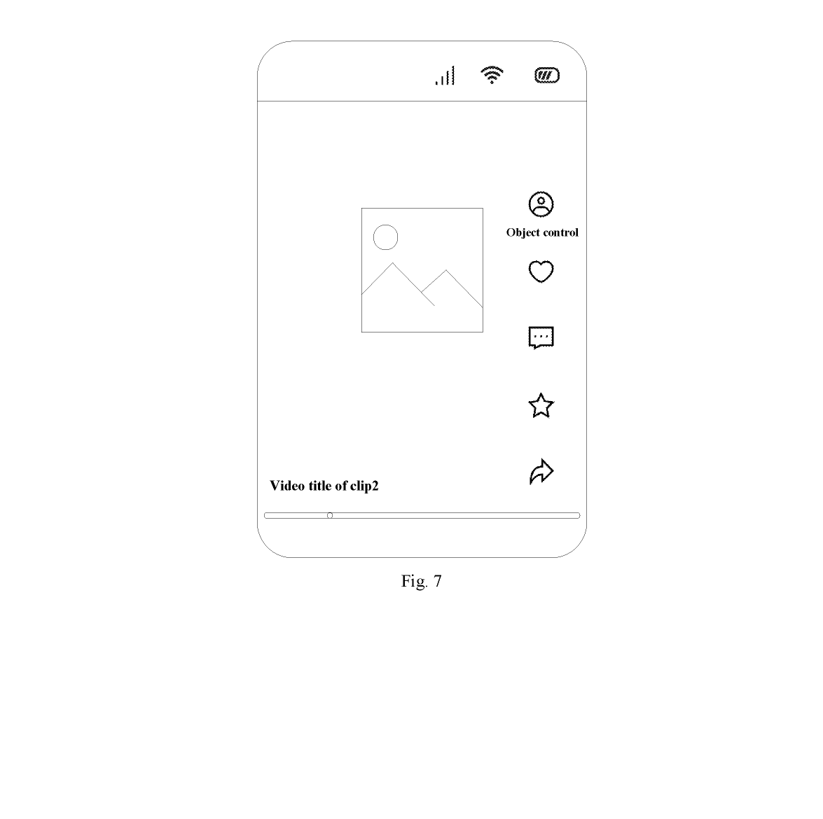

As a specific application example, a target application is installed on the media service platform, and the target application is configured with the video recommendation method of the present disclosure. In the target application, a historical live streaming video may be determined by configuring a first condition (such as an account of a live streaming object). Then, the target application displays a display unit of at least one video segment in the historical live streaming video through a second page. A user may select a first video segment to be recommended according to actual needs. For example, when the user needs to display a product A through live streaming, the user may select a video segment used to display the product A in the historical live streaming video, such as a video segment clip2, as the first video segment to be recommended. The media service platform pushes the video segment clip2, and the receiver displays the video segment clip2 on a recommendation page according to the video segment clip2 pushed by the media service platform. Referring to FIG. 7, other users may click to play the video segment clip2 through a terminal device where the receiver is located. When the receiver plays the video segment clip2, an object control (such as an avatar) of the live streaming object is displayed in a display area of the video segment clip2, and the object control is associated with a live streaming link through which the live streaming object is streaming. Furthermore, a user of the receiver may interact with the object control of the live streaming object to cause the receiver to display a current live streaming video of the live streaming object through the live streaming link.

It should be noted that, in the video recommendation method of the present disclosure, the historical live streaming video may be automatically determined according to the first condition input on the first page. The display unit of the video segment in the historical live streaming video is displayed in the display area of the second page to select the video segment to be pushed. Therefore, there is no need to configure corresponding plan details for a type of the video segment to be pushed, which may help users without video material production capabilities to automatically clip video segments with better effectiveness of live streaming, so that the users may select required video segments therefrom for pushing, thereby improving a recommendation effect of live streaming videos of the users. Meanwhile, in order to assist the users in selecting video segments, the video segments are arranged and displayed by using the display units, so as to highlight the analysis data of the video segments by using the display units. Therefore, more decision-making information may be provided to the users to facilitate selection of appropriate video segments for pushing, so that more exposure is provided for the live streaming videos of the users by using the pushed video segments, thereby improving the effectiveness of live streaming.

In this embodiment, a video recommendation apparatus is further provided. The apparatus is used to implement the above embodiments and preferred implementations, which will not be repeated here. As used below, the term "module" may implement a combination of software and/or hardware for a predetermined function. Although the apparatus described in the following embodiments is preferably implemented in software, implementation in hardware, or a combination of software and hardware is also possible and contemplated.

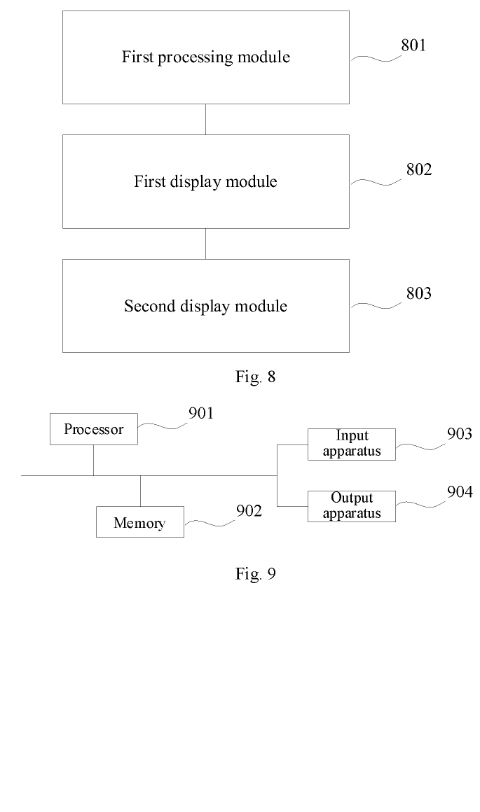

This embodiment provides a video recommendation apparatus, as shown in FIG. 8, including:

a first processing module 801, configured to determine, in response to a first condition input on a first page, a historical live streaming video satisfying the first condition;

a first display module 802, configured to display, in a display area of a second page, a display unit of at least one video segment in the historical live streaming video, where the display unit is configured to display the video segment and analysis data of the video segment, the video segment is used to display a product, and the video segment is determined based on effectiveness of live streaming of respective live streaming clips from the historical live streaming video; and

a second display module 803, configured to display, in a display area of the first page, a first video segment in response to a selection instruction for the first video segment in the at least one video segment, where the first video segment is a video segment for recommendation.

In some optional implementations, the first page further displays a trigger control for triggering display of the second page. The first display module 802 includes:

a first display unit, configured to display the second page in response to an interaction operation on the trigger control, where a condition area of the second page displays a filtering control for attribute information of the video segment;

an interaction unit, configured to determine a second condition in response to an interaction operation on the filtering control; and

a second display unit, configured to display, in the second page, the display unit of the video segment that satisfies the second condition.

In some optional implementations, the analysis data includes the attribute information of the video segment, and the attribute information includes at least one of: live streaming information of the historical live streaming video to which the video segment belongs, displayed product information, and live streaming time.

In some optional implementations, the analysis data includes an analysis result of at least one analysis indicator, and the second page further displays a sorting control for the at least one analysis indicator, where the sorting control is used to sort and display the display units in the second page based on the analysis indicator.

In some optional implementations, the analysis data includes a target description word of voice-over script in the video segment.

In some optional implementations, the video recommendation apparatus of the present disclosure further includes:

a third display module, configured to present, in a third page, a second video segment, a target description word of the second video segment, and voice-over information of the target description word in voice-over script, in response to an interaction operation on the second video segment in the at least one video segment.

In some optional implementations, the video recommendation apparatus of the present disclosure further includes:

a second processing module, configured to determine, in response to an interaction operation on the target description word or the voice-over information, a target time point in the second video segment corresponding to the target description word or the voice-over information; and

a video playing module, configured to play the second video segment from the target time point.

In some optional implementations, the first page further displays a preview area. The video recommendation apparatus of the present disclosure further includes:

a preview module, configured to display, in the preview area, preview content of a selected first video segment in response to a selection operation for the first video segment in the first page.

In some optional implementations, the first page further displays a push control and a recommendation configuration item for the first video segment. The video recommendation apparatus of the present disclosure further includes:

an acquisition module, configured to acquire a live streaming link that satisfies the first condition;

a configuration module, configured to determine, in response to a configuration operation for the recommendation configuration item, recommendation information of the first video segment; and

a pushing module, configured to push the first video segment, the recommendation information and the live streaming link in response to an interaction operation on the push control, where related display content of the first video segment is related to the recommendation information and the live streaming link.

Further functional descriptions of the above modules and units are the same as those in the corresponding embodiments above, and are not repeated herein.

The video recommendation apparatus in this embodiment is presented in the form of functional units, and the units here refer to an ASIC (Application Specific Integrated Circuit) circuit, a processor and a memory that execute one or more software or fixed programs, and/or other devices that may provide the above functions.

An embodiment of the present disclosure further provides an electronic device having the video recommendation apparatus shown in FIG. 8 above.

Please refer to FIG. 9. FIG. 9 is a structural block diagram of an electronic device provided by an optional embodiment of the present disclosure. As shown in FIG. 9, the electronic device includes: one or more processors 901, a memory 902, and interfaces for connecting various components, including high-speed interfaces and low-speed interfaces. The components communicate with each other using different buses and may be installed on a common main board or in other ways as needed. The processor may process instructions executed within the electronic device, including instructions stored in or on the memory to display graphical information of GUI on an external input/output apparatus (such as a display device coupled to the interface). In some optional implementations, if required, multiple processors and/or buses may be used with multiple memories and multiple memories. Similarly, multiple electronic devices may be connected, and each device provides some necessary operations (for example, as a server array, a group of blade servers, or a multi-processor system). In FIG. 9, one processor 901 is taken as an example.

The processor 901 may be a central processing unit, a network processor or a combination thereof. The processor 901 may further include a hardware chip. The hardware chip may be an application specific integrated circuit, a programmable logic device or a combination thereof. The programmable logic device may be a complex programmable logic device, a field programmable logic gate array, a generic array logic, or any combination thereof.

The memory 902 stores instructions executable by at least one processor 901, so that the at least one processor 901 executes the method shown in the above embodiments.

The memory 902 may include a program storage area and a data storage area, where the program storage area may store an application program required by an operating system and at least one function; the data storage area may store data created according to the use of the electronic device, and the like. In addition, the memory 902 may include a high-speed random access memory or a non-transitory memory, such as at least one magnetic disk storage device, a flash memory device, or other non-transitory solid-state storage devices. In some optional implementations, the memory 902 optionally includes memories remotely provided with respect to the processor 901, and these remote memories may be connected to the electronic device through a network. Examples of the above network include, but are not limited to, Internet, an intranet, a local area network, a mobile communication network, and a combination thereof.

The memory 902 may include a volatile memory, such as a random access memory; the memory may also include a non-volatile memory, such as a flash memory, a hard disk or a solid state disk; the memory 902 may also include a combination of the above types of memories.

The electronic device further includes an input apparatus 903 and an output apparatus 904. The processor 901, the memory 902, the input apparatus 903 and the output apparatus 904 may be connected through a bus or in other ways. In FIG. 9, connection through a bus is used as an example.

The input apparatus 903 may receive input digital or character information, and generate a key signal input related to user settings and function control of the electronic device, such as a touch screen, a keypad, a mouse, a track pad, a touch panel, an indicator stick, one or more mouse buttons, a trackball, a joystick, and the like. The output apparatus 904 may include a display device, an auxiliary lighting apparatus (such as an LED), a tactile feedback apparatus (such as a vibration motor), and the like. The above display device includes, but is not limited to, a liquid crystal display, a light emitting diode, a display and a plasma display. In some optional implementations, the display device may be a touch screen.

An embodiment of the present disclosure further provides a computer-readable storage medium. The method according to the embodiment of the present disclosure may be implemented in hardware and firmware, or implemented as computer code that may be recorded in a storage medium or originally stored in a remote storage medium or a non-transitory machine-readable storage medium and downloaded through a network and will be stored in a local storage medium. Therefore, the method described herein may be stored in such software processing on a storage medium using a general-purpose computer, a dedicated processor, or programmable or dedicated hardware. The storage medium may be a magnetic disk, an optical disk, a read-only memory, a random access memory, a flash memory, a hard disk or a solid state disk, and the like; further, the storage medium may also include a combination of the above types of memories. It may be understood that the computer, the processor, the microprocessor controller or the programmable hardware includes a storage component that may store or receive software or computer code, and when the software or computer code is accessed and executed by the computer, the processor or the hardware, the method shown in the above embodiments is implemented.

A portion of the present disclosure may be applied as a computer program product, such as computer program instructions, which, when executed by a computer, may invoke or provide the method and/or technical solution according to the present disclosure through operations of the computer. Those skilled in the art should understand that the computer program instructions exist in a computer-readable medium in a form including, but not limited to, a source file, an executable file, an installation package file, etc. Accordingly, the computer program instructions are executed by the computer in a manner including, but not limited to: the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium accessible by the computer.

Although the embodiments of the present disclosure are described in combination with the drawings, those skilled in the art may make various modifications and variations without departing from the spirit and scope of the present disclosure, and such modifications and variations are within the scope defined by the appended claims.

What is claimed is:

1. A video recommendation method, comprising:
determining, in response to a first condition input on a first page, a historical live streaming video satisfying the first condition;
displaying, in a display area of a second page, a display unit of at least one video segment in the historical live streaming video, wherein the display unit is configured to display the video segment and analysis data of the video segment, the video segment is configured to display a product, and the video segment is determined based on effectiveness of live streaming of respective live streaming clips from the historical live streaming video; and
displaying, in a display area of the first page, a first video segment in response to a selection instruction for the first video segment in the at least one video segment, wherein the first video segment is a video segment for recommendation.

2. The video recommendation method of claim 1, wherein the first page further displays a trigger control for triggering display of the second page; and the displaying, in the display area of the second page, the display unit of the at least one video segment in the historical live streaming video comprises:
displaying the second page in response to an interaction operation on the trigger control, wherein a condition area of the second page displays a filtering control for attribute information of the video segment;
determining a second condition in response to an interaction operation on the filtering control; and
displaying, in the second page, the display unit of the video segment that satisfies the second condition.

3. The video recommendation method of claim 1, wherein the analysis data comprises attribute information of the video segment, and the attribute information comprises at least one of: live streaming information of the historical live streaming video to which the video segment belongs, displayed product information, or live streaming time.

4. The video recommendation method of claim 1, wherein the analysis data comprises an analysis result of at least one analysis indicator, and the second page further displays a sorting control for the at least one analysis indicator, wherein the sorting control is configured to sort and display the display units in the second page based on the analysis indicator.

5. The video recommendation method of claim 1, wherein the analysis data comprises a target description word of voice-over script in the video segment.

6. The video recommendation method of claim 5, wherein the method further comprises:
in response to an interaction operation on a second video segment in the at least one video segment, presenting, in a third page, the second video segment, a target description word of the second video segment, and voice-over information of the target description word in voice-over script.

7. The video recommendation method of claim 6, further comprising:
determining, in response to an interaction operation on the target description word or the voice-over information, a target time point in the second video segment corresponding to the target description word or the voice-over information; and
playing the second video segment from the target time point.

8. The video recommendation method of claim 1, wherein the first page further displays a preview area; and the method further comprises:
in response to a selection operation for the first video segment in the first page, displaying, in the preview area, preview content of a selected first video segment.

9. The video recommendation method of claim 1, wherein the first page further displays a push control and a recommendation configuration item for the first video segment; and the method further comprises:
acquiring a live streaming link that satisfies the first condition;
determining, in response to a configuration operation for the recommendation configuration item, recommendation information of the first video segment; and
pushing the first video segment, the recommendation information and the live streaming link in response to an interaction operation on the push control, wherein related display content of the first video segment is related to the recommendation information and the live streaming link.

10. An electronic device, comprising:
a memory and a processor, wherein the memory and the processor are communicatively connected to each other, the memory stores computer instructions, and the processor executes the computer instructions to implement a video recommendation method, comprising:
determining, in response to a first condition input on a first page, a historical live streaming video satisfying the first condition;
displaying, in a display area of a second page, a display unit of at least one video segment in the historical live streaming video, wherein the display unit is configured to display the video segment and analysis data of the video segment, the video segment is configured to display a product, and the video segment is determined based on effectiveness of live streaming of respective live streaming clips from the historical live streaming video; and
displaying, in a display area of the first page, a first video segment in response to a selection instruction for the first video segment in the at least one video segment, wherein the first video segment is a video segment for recommendation.

11. The electronic device of claim 10, wherein the first page further displays a trigger control for triggering display of the second page; and the displaying, in the display area of the second page, the display unit of the at least one video segment in the historical live streaming video comprises:
displaying the second page in response to an interaction operation on the trigger control, wherein a condition area of the second page displays a filtering control for attribute information of the video segment;
determining a second condition in response to an interaction operation on the filtering control; and
displaying, in the second page, the display unit of the video segment that satisfies the second condition.

12. The electronic device of claim 10, wherein the analysis data comprises attribute information of the video segment, and the attribute information comprises at least one of: live streaming information of the historical live streaming video to which the video segment belongs, displayed product information, or live streaming time.

13. The electronic device of claim 10, wherein the analysis data comprises an analysis result of at least one analysis indicator, and the second page further displays a sorting control for the at least one analysis indicator, wherein the sorting control is configured to sort and display the display units in the second page based on the analysis indicator.

14. The electronic device of claim 10, wherein the analysis data comprises a target description word of voice-over script in the video segment.

15. The electronic device of claim 14, wherein the method further comprises:
in response to an interaction operation on a second video segment in the at least one video segment, presenting, in a third page, the second video segment, a target description word of the second video segment, and voice-over information of the target description word in voice-over script.

16. The electronic device of claim 15, further comprising:
determining, in response to an interaction operation on the target description word or the voice-over information, a target time point in the second video segment corresponding to the target description word or the voice-over information; and
playing the second video segment from the target time point.

17. The electronic device of claim 10, wherein the first page further displays a preview area; and the method further comprises:
in response to a selection operation for the first video segment in the first page, displaying, in the preview area, preview content of a selected first video segment.

18. The electronic device of claim 10, wherein the first page further displays a push control and a recommendation configuration item for the first video segment; and the method further comprises:
acquiring a live streaming link that satisfies the first condition;
determining, in response to a configuration operation for the recommendation configuration item, recommendation information of the first video segment; and
pushing the first video segment, the recommendation information and the live streaming link in response to an interaction operation on the push control, wherein related display content of the first video segment is related to the recommendation information and the live streaming link.

19. A non-transitory computer-readable storage medium storing computer instructions, wherein the computer instructions are configured to cause a computer to perform a video recommendation method, comprising:
determining, in response to a first condition input on a first page, a historical live streaming video satisfying the first condition;
displaying, in a display area of a second page, a display unit of at least one video segment in the historical live streaming video, wherein the display unit is configured to display the video segment and analysis data of the video segment, the video segment is configured to display a product, and the video segment is determined based on effectiveness of live streaming of respective live streaming clips from the historical live streaming video; and
displaying, in a display area of the first page, a first video segment in response to a selection instruction for the first video segment in the at least one video segment, wherein the first video segment is a video segment for recommendation.

20. The non-transitory computer-readable storage medium of claim 19, wherein the first page further displays a trigger control for triggering display of the second page; and the displaying, in the display area of the second page, the display unit of the at least one video segment in the historical live streaming video comprises:
displaying the second page in response to an interaction operation on the trigger control, wherein a condition area of the second page displays a filtering control for attribute information of the video segment;
determining a second condition in response to an interaction operation on the filtering control; and
displaying, in the second page, the display unit of the video segment that satisfies the second condition.
